(19) United States
(12) Patent Application Publication
(10) Pub. No.: US 2015/0354467 A1
(43) Pub. Date: Dec. 10, 2015

(54) GAS TURBINE SYSTEM, GAS TURBINE COMBUSTOR CONTROL DEVICE, AND GAS TURBINE COMBUSTOR CONTROL METHOD

(71) Applicant: Mitubishi Hitachi Power Systems, Ltd., Yokohama-shi, Kanagawa (JP)

(72) Inventors: Makoto KISHI, Tokyo (JP); Takashi SONODA, Tokyo (JP); Shinya UCHIDA, Tokyo (JP); Sosuke NAKAMURA, Tokyo (JP); Yoshikazu MATSUMURA, Tokyo (JP); Satoko FUJII, Tokyo (JP); Tetsuya YABE, Tokyo (JP); Ryoichi HAGA, Tokyo (JP)

(21) Appl. No.: 14/760,519

(22) PCT Filed: Feb. 18, 2014
(86) PCT No.: PCT/JP2014/053754

§ 371 Date: Jul. 13, 2015

(30) Foreign Application Priority Data
Feb. 20, 2013 (JP) 2013-031186

(51) Int. Cl. F02C 9/28; F02C 7/22; F02C 9/20

(52) U.S. Cl. CPC F02C 9/28; F02C 9/20; F02C 7/222; F05D 2220/32; F05D 2240/40; F05D 2260/80; F05D 2270/091; F05D 2270/331

(57) ABSTRACT

A gas turbine is provided with a combustor having a pilot nozzle, a first main nozzle, and a second main nozzle. A combustor control device has a load interruption detector which detects load interruption of the gas turbine, a pilot nozzle flow rate control unit which increases the amount of premixed fuel supplied to the pilot nozzle, based on the detection of the load interruption, a first main nozzle flow rate control unit which reduces the amount of premixed fuel supplied to the first main nozzles, based on the detection of the load interruption, and a second main nozzle flow rate control unit which reduces the amount of premixed fuel supplied to the second main nozzles to a predetermined amount, based on the detection of the load interruption, and then further reduces the amount of premixed fuel supplied after the elapse of a predetermined time.

### TECHNICAL FIELD

The present invention relates to a gas turbine system, a gas turbine combustor control device, and a gas turbine combustor control method.

Priority is claimed on Japanese Patent Application No. 2013-031186, filed Feb. 20, 2013, the content of which is incorporated herein by reference.

### BACKGROUND ART

A gas turbine combustor is incorporated into a gas turbine plant or a combined cycle power plant, and a gas turbine is driven by introducing a combustion gas from the gas turbine combustor into the gas turbine.

As techniques related to such a background, various techniques are known (refer to, for example, Patent Literature 1).

In a gas turbine system disclosed in Patent Literature 1, specifically, a first main nozzle function generator outputs a first main nozzle control signal based on a predetermined function value according to a load. A second main nozzle function generator outputs a second main nozzle control signal based on a predetermined function value according to the operating conditions of a gas turbine. A tracking circuit outputs a third main nozzle control signal by making the second main nozzle control signal follow the first main nozzle control signal.

A pilot nozzle function generator outputs a control signal based on a predetermined function value in order to open and close a pilot nozzle distribution valve according to the third main nozzle control signal, and this signal is used as a pilot nozzle control signal. Control means uses the third main nozzle control signal as a main nozzle control signal. In this manner, according to this gas turbine system, it is possible to perform stable two-stage combustion, and thus it is possible to prevent misfire of a pilot nozzle by making the pilot nozzle distribution valve have a predetermined opening degree at the time of load interruption.

Further, in the past, in a gas turbine which is used in a power plant or the like, power generation has been performed by supplying compressed air and fuel to a combustor and rotating a turbine by using a high-temperature combustion gas due to combustion in the combustor.

As techniques related to such a background, various techniques are known (refer to, for example, Patent Literature 2).

In a gas turbine system disclosed in Patent Literature 2, specifically, a first information acquisition unit acquires a pilot ratio of fuel which is supplied to a combustor. A second information acquisition unit acquires the flow rate of air which is supplied to the combustor. A target fuel-air ratio acquisition unit has combustion maintenance limit information indicating the relationship between the pilot ratio and the fuel-air ratio, which is determined by the stability of a combustion state in the combustor. In addition, the target fuel-air ratio acquisition unit acquires a fuel-air ratio corresponding to the pilot ratio acquired by the first information acquisition unit, from the combustion maintenance limit information, and outputs the fuel-air ratio as a target fuel-air ratio. A command creation unit determines a minimum fuel command by using the target fuel-air ratio and the air flow rate acquired by the second information acquisition unit. In this manner, according to this gas turbine system, it is possible to reliably maintain combustion in the combustor even in a case where an event that a load rapidly decreases, as in load interruption or an auxiliary load, occurs.

### CITATION LIST

### Patent Literature

[Patent Literature 1] Japanese Unexamined Patent Application, First Publication No. H05-149544

[Patent Literature 2] Japanese Unexamined Patent Application, First Publication No. 2011-085105

### SUMMARY OF INVENTION

### Technical Problem

However, the technique disclosed in Patent Literature 1 is for causing main fuel to track a setting value, and it is not possible to control a cutting timing at the time of staging, and therefore, it is not possible to reliably prevent misfire of the combustor.

In the technique disclosed in Patent Literature 2, although stable combustion can be performed at the time of load interruption, the technique not only does not target a premixed pilot, but also does not take into account staging of a main nozzle, and therefore, it is not possible to reliably prevent misfire of the combustor.

### Solution to Problem

According to a first aspect of the present invention, there is provided a gas turbine system including: a gas turbine; and a combustor control device. The gas turbine is provided with a combustor having a pilot nozzle which injects premixed fuel, and a first main nozzle and a second main nozzle which are provided around the pilot nozzle and inject premixed fuel. The combustor control device has a load interruption detector which detects load interruption of the gas turbine, a pilot nozzle flow rate control unit which increases the amount of premixed fuel supplied to the pilot nozzle, based on detection of the load interruption, a first main nozzle flow rate control unit which reduces the amount of premixed fuel supplied to the first main nozzle, based on detection of the load interruption, and a second main nozzle flow rate control unit which reduces the amount of premixed fuel supplied to the second main nozzle to a predetermined amount, based on detection of the load interruption, and then further reduces the amount of premixed fuel supplied after the elapse of a predetermined time.

The combustor control device may temporarily reduce the flow rate of the first main nozzle, based on detection of the load interruption.

The combustor control device may reduce the amount of premixed fuel supplied to the second main nozzle with a parameter required for a flame as an indicator.

The combustor control device may set delay time when reducing the amount of premixed fuel supplied to the second main nozzle to a predetermined amount, based on detection of the load interruption, and then further reducing the amount of premixed fuel supplied after the elapse of a predetermined time.

The combustor control device may include adjustment of the opening degree of an inlet guide vane provided in the gas turbine.

According to a second aspect of the present invention, there is provided a gas turbine combustor control device including: a load interruption detector which detects load interruption of a gas turbine; a pilot nozzle flow rate control unit which increases the amount of premixed fuel supplied to a pilot nozzle, based on detection of the load interruption; a first main nozzle flow rate control unit which reduces the amount of premixed fuel supplied to a first main nozzle, based on detection of the load interruption; and a second main nozzle flow rate control unit which reduces the amount of premixed fuel supplied to a second main nozzle to a predetermined amount, based on detection of the load interruption, and then further reduces the amount of premixed fuel supplied after the elapse of a predetermined time.

According to a third aspect of the present invention, there is provided a gas turbine combustor control method including: a load interruption detection step of detecting load interruption of a gas turbine; a pilot nozzle flow rate control step of increasing the amount of premixed fuel supplied to a pilot nozzle, based on detection of the load interruption; a first main nozzle flow rate control step of reducing the amount of premixed fuel supplied to a first main nozzle, based on detection of the load interruption; and a second main nozzle flow rate control step of reducing the amount of premixed fuel supplied to a second main nozzle to a predetermined amount, based on detection of the load interruption, and then further reducing the amount of premixed fuel supplied after the elapse of a predetermined time.

In addition, the above aspects of the invention are not intended to recite all of the necessary features of the present invention.

### Advantageous Effects of Invention

According to the gas turbine system, the gas turbine combustor control device, and the gas turbine combustor control method described above, it is possible to reliably prevent misfire of the combustor.

### BRIEF DESCRIPTION OF DRAWINGS

FIG. 1 is a conceptual block configuration diagram of a gas turbine system of a first embodiment.

FIG. 2 is a schematic diagram of the gas turbine system of the first embodiment.

FIG. 3 is schematic cross-sectional view of a combustor in a gas turbine of the first embodiment.

FIG. 4 is a schematic circuit diagram of a gas turbine combustor control device of the first embodiment.

FIG. 5 is a timing chart describing a gas turbine combustor control method of the first embodiment.

FIG. 6 is a timing chart describing a gas turbine combustor control method of a second embodiment.

FIG. 7 is a schematic circuit diagram of a gas turbine combustor control device of a third embodiment.

FIG. 8 is a schematic circuit diagram of a gas turbine combustor control device of a fourth embodiment.

FIG. 9 is a timing chart describing a gas turbine combustor control method of the fourth embodiment.

FIG. 10 is a timing chart describing a gas turbine combustor control method of a fifth embodiment.

### DESCRIPTION OF EMBODIMENTS

Hereinafter, the present invention will be described through embodiments of the invention. However, the following embodiments do not limit the present invention. Further, all of the combinations of features described in the embodiments are not necessarily essential solutions in the present invention.

### First Embodiment

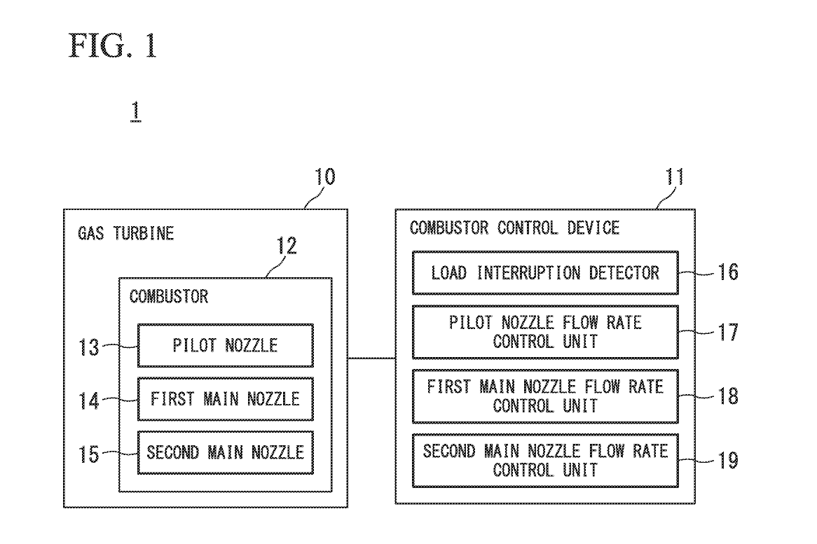

FIG. 1 is a conceptual block configuration diagram of a gas turbine system of a first embodiment. As shown in FIG. 1, a gas turbine system 1 includes a gas turbine 10 and a combustor control device 11. The gas turbine 10 is provided with a combustor 12. The combustor 12 is provided with a pilot nozzle 13, a first main nozzle 14, and a second main nozzle 15. The combustor control device 11 is provided with a load interruption detector 16, a pilot nozzle flow rate control unit 17, a first main nozzle flow rate control unit 18, and a second main nozzle flow rate control unit 19.

The pilot nozzle 13 injects a premixed fuel gas. The first main nozzle 14 injects a premixed fuel gas around the pilot nozzle 13. The second main nozzle 15 injects a premixed fuel gas around the pilot nozzle 13, similar to the first main nozzle 14. The load interruption detector 16 detects load interruption of the gas turbine 10. The pilot nozzle flow rate control unit 17 increases the amount of premixed fuel supplied to the pilot nozzle 13, based on the detection of the load interruption. The first main nozzle flow rate control unit 18 reduces the amount of premixed fuel supplied to the first main nozzles 14, based on the detection of the load interruption. The second main nozzle flow rate control unit 19 reduces the amount of premixed fuel supplied to the second main nozzles 15 to a predetermined amount, based on the detection of the load interruption, and then further reduces the amount of premixed fuel supplied after the elapse of a predetermined time. In addition, as a main nozzle, there is no limitation to the first main nozzle 14 and the second main nozzle 15 and a plurality of main nozzles including a third main nozzle or a fourth main nozzle may be provided. In this case, among the plurality of groups of main nozzles, several systems are reserved for rotating speed control and the several remaining systems perform control such as performing a decrease in the amount of premixed fuel supplied with a time difference.

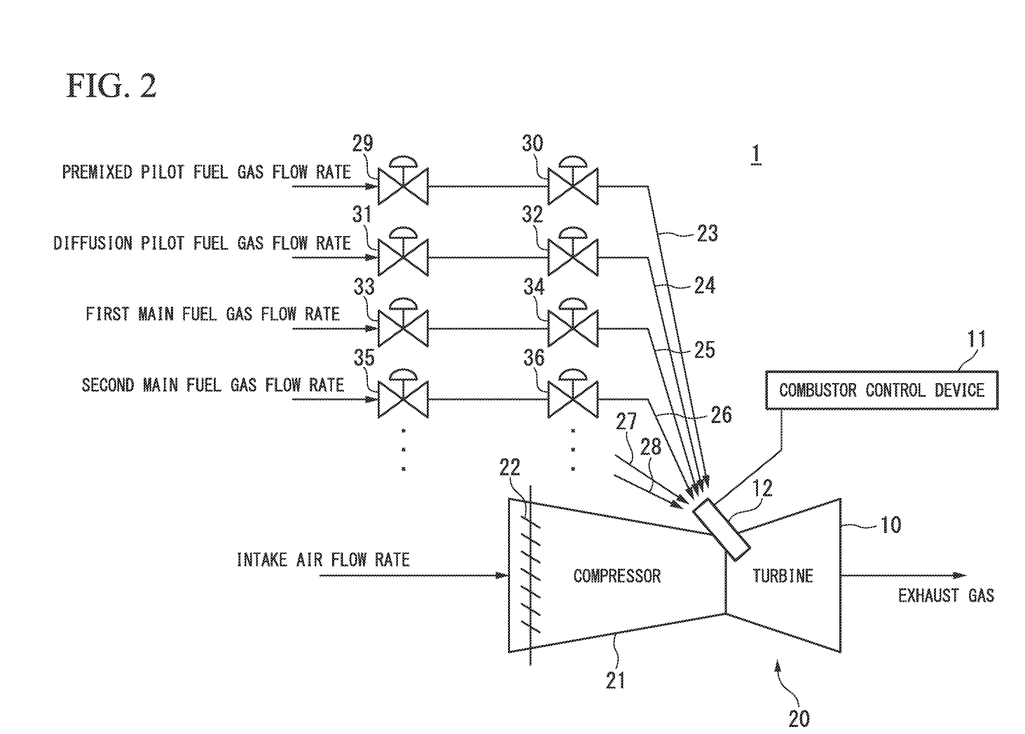

FIG. 2 is a schematic diagram of the gas turbine system of the first embodiment. As shown in FIG. 2, the gas turbine 10 has a compressor 21 on the air intake side of a turbine main body 20. The gas turbine 10 is provided with an inlet guide vane 22 for adjusting the amount of intake air on the intake side of intake air. A premixed pilot fuel gas flow path 23, a diffusion pilot fuel gas flow path 24, a first main nozzle fuel gas flow path 25, and a second main nozzle fuel gas flow path 26 are connected to the combustor 12 so as to communicate therewith. In addition, a plurality of top hat fuel gas flow paths such as a first top hat fuel gas flow path 27 and a second top hat fuel gas flow path 28 are connected to the combustor 12 so as to communicate therewith.

A premixed combustion pilot pressure regulating valve 29 and a premixed combustion pilot flow regulating valve 30 in order from the upstream side of a fuel gas toward the downstream side are connected to the premixed pilot fuel gas flow path 23 so as to communicate therewith. A diffusion combustion pilot pressure regulating valve 31 and a diffusion combustion pilot flow regulating valve 32 in order from the upstream side of a fuel gas toward the downstream side are connected to the diffusion pilot fuel gas flow path 24 so as to communicate therewith.

A first main nozzle pressure regulating valve 33 and a first main nozzle flow regulating valve 34 in order from the upstream side of a fuel gas toward the downstream side are connected to the first main nozzle fuel gas flow path 25 so as to communicate therewith. A second main nozzle pressure regulating valve 35 and a second main nozzle flow regulating valve 36 in order from the upstream side of a fuel gas toward the downstream side are connected to the second main nozzle fuel gas flow path 26 so as to communicate therewith.

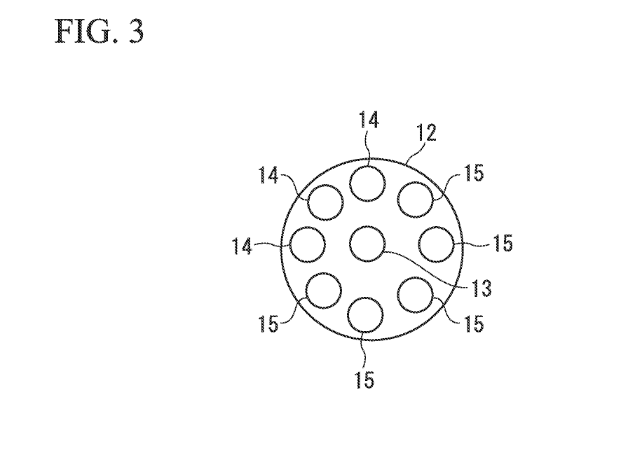

FIG. 3 is schematic cross-sectional view of the combustor in the gas turbine of the first embodiment. As shown in FIG. 3, in the combustor 12, the pilot nozzle 13 is provided at the center and three first main nozzles 14 are provided side by side in a circumferential direction on the outer periphery side of the pilot nozzle 13. Further, in the combustor 12, five second main nozzles 15 are provided side by side in the circumferential direction on the outer periphery side of the pilot nozzle 13. In addition, the disposition or the number of the respective nozzles can be set appropriately.

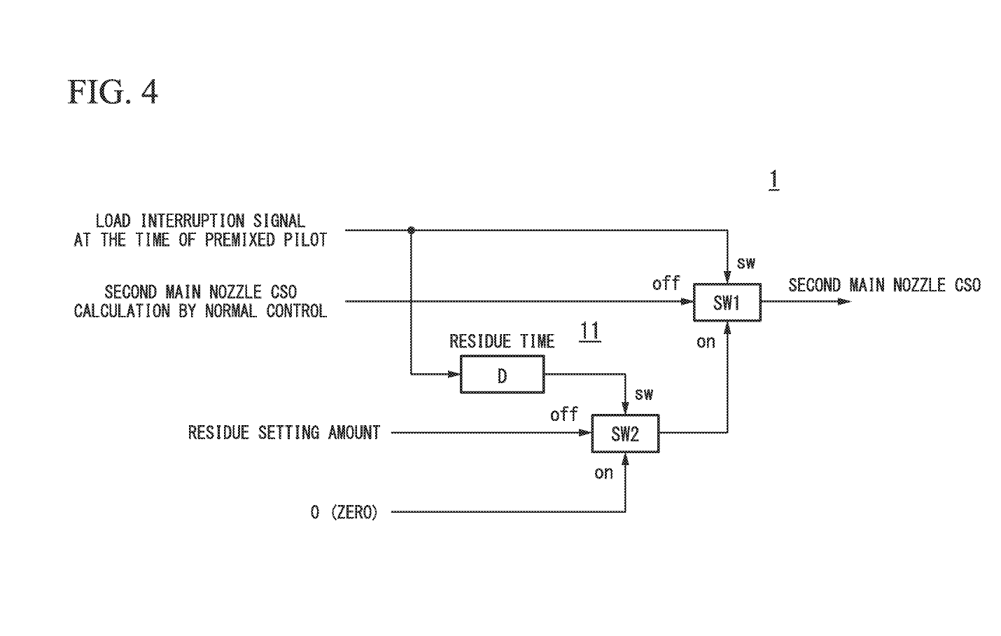

FIG. 4 is a schematic circuit diagram of a gas turbine combustor control device of the first embodiment. As shown in FIG. 4, in the combustor control device 11, a load interruption signal at the time of premixed pilot is input to a first switch SW1. Further, the load interruption signal at the time of premixed pilot is input to a second switch SW2 with residue time set by a delay circuit D. A fuel flow rate command calculation signal of the second main nozzle 15 by normal control is input to off input of the first switch SW1. A residue setting amount signal is input to off input of the second switch SW2. A zero signal is input to on input of the second switch SW2. The second switch SW2 performs input to on input of the first switch SW1. The combustor control device 11 determines, in the first switch SW1, a fuel flow rate command to the second main nozzle 15 by normal control. In contrast, at the time of load interruption, after delay time is set in the delay circuit D, a fuel flow rate command to the second main nozzle 15 is determined through the second switch SW2 and the first switch SW1.

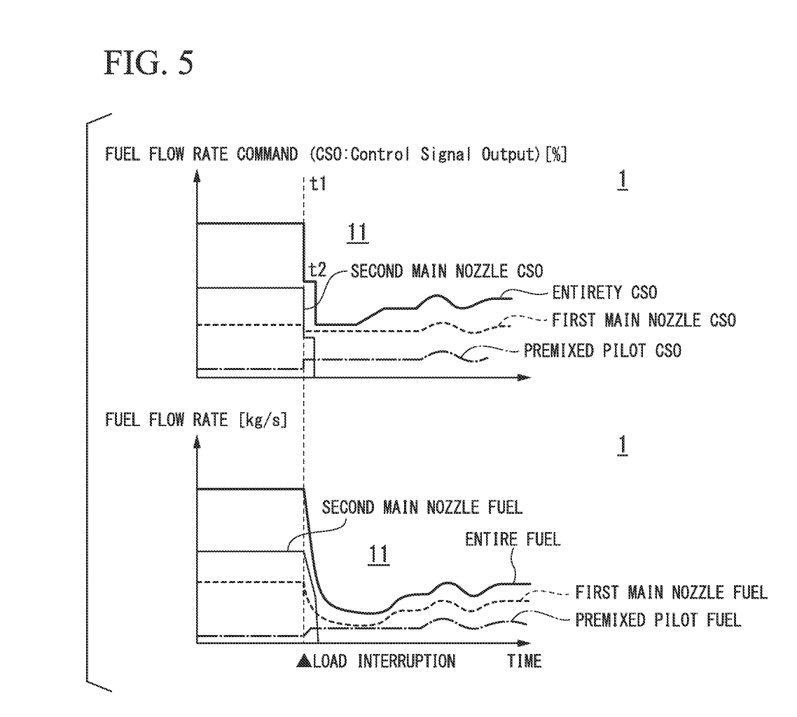

FIG. 5 is a timing chart describing a gas turbine combustor control method of the first embodiment. As shown in FIG. 5, if there is a load interruption command at time t1, the combustor control device 11 detects the load interruption command. After time t1, the pilot nozzle flow rate control unit 17 increases the amount of premixed fuel supplied to the pilot nozzle 13 due to the detection of the load interruption command. Therefore, at time t2 after time t1, the first main nozzle flow rate control unit 18 reduces the amount of premixed fuel supplied to the first main nozzle 14. Then, the second main nozzle flow rate control unit 19 further reduces the amount of premixed fuel supplied after time t2 when the amount of premixed fuel supplied of the premixed fuel gas to the second main nozzle 15 has been reduced to a predetermined amount. Thus, the second main nozzle 15 continues the supply of a predetermined amount of fuel gas for a predetermined period of time. Then, during this time, flame holding is performed by starting the supply of the premixed pilot fuel gas.

According to the gas turbine system 1 of the first embodiment, at the time of load interruption, a premixed pilot fuel gas is increased and the supply of a predetermined amount of fuel gas is continued for a predetermined period of time without immediately interrupting the second main nozzle 15. Then, during this time, the supply of the premixed pilot fuel gas is started. Therefore, according to the gas turbine system 1, it is possible to reliably prevent misfire of the combustor 12 by promoting flame diffusion from a main system.

According to the combustor control device 11 of the first embodiment, the supply of a predetermined amount of fuel gas is continued by the second main nozzle 15 for a predetermined period of time, and during this time, the supply of the premixed pilot fuel gas is started. Therefore, according to the combustor control device 11, the misfire of the combustor 12 can be prevented by flame holding.

According to the gas turbine combustor control method of the first embodiment, the supply of a predetermined amount of fuel gas is continued by the second main nozzle 15 for a predetermined period of time, and during this time, the supply of the premixed pilot fuel gas is started. Therefore, according to the gas turbine combustor control method, the misfire of the combustor 12 can be prevented by flame holding.

### Second Embodiment

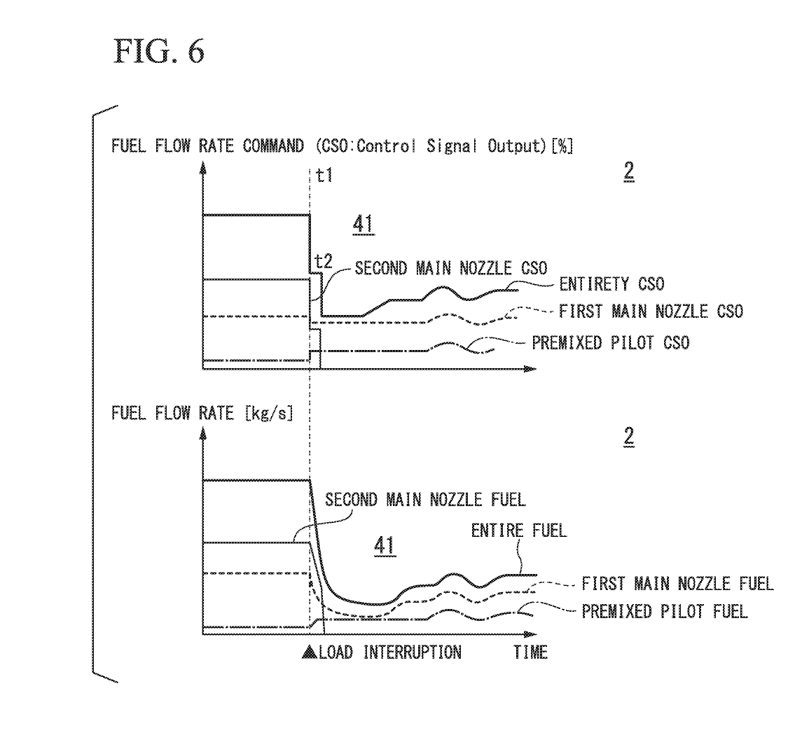

Next, a second embodiment will be described with reference to FIG. 6. However, the same sites as those in the first embodiment are denoted by the same reference numerals and description thereof is omitted, and only different points are described. FIG. 6 is a timing chart describing a gas turbine combustor control method of the second embodiment. As shown in FIG. 6, a gas turbine system 2 of the second embodiment is provided with a combustor control device 41. In the gas turbine combustor control method of this embodiment, at the time of load interruption at time t1, a premixed pilot fuel gas is increased and the supply of a predetermined amount of fuel gas is continued for a predetermined period of time without immediately interrupting the second main nozzle 15. Then, during the period until time t2 after time t1, the amount of fuel gas supplied to the first main nozzle 14 is temporarily reduced.

According to the gas turbine system 2 of the second embodiment, at the time of load interruption, a premixed pilot fuel gas is increased and the supply of a predetermined amount of fuel gas is continued for a predetermined period of time without immediately interrupting the second main nozzle 15. Then, during this time, the supply of the premixed pilot fuel gas is started and the amount of fuel gas supplied to the first main nozzle 14 is temporarily reduced. Therefore, according to the gas turbine system 2, it can be provided with the combustor control device 41 in which it is possible to suppress a significant increase in the rotating speed of the gas turbine 10.

According to the combustor control device 41 of the second embodiment, the supply of a predetermined amount of fuel gas is continued by the second main nozzle 15 for a predetermined period of time, and during this time, the supply of the premixed pilot fuel gas is started and the amount of fuel gas supplied to the first main nozzle 14 is temporarily reduced. Therefore, according to the combustor control device 41, it is possible to suppress a significant increase in the rotating speed of the gas turbine 10.

According to the gas turbine combustor control method of the second embodiment, the supply of a predetermined amount of fuel gas is continued by the second main nozzle 15 for a predetermined period of time, and during this time, the supply of the premixed pilot fuel gas is started and the amount of fuel gas supplied to the first main nozzle 14 is temporarily reduced. Therefore, according to the gas turbine combustor control method of this embodiment, it is possible to suppress a significant increase in the rotating speed of the gas turbine 10.

### Third Embodiment

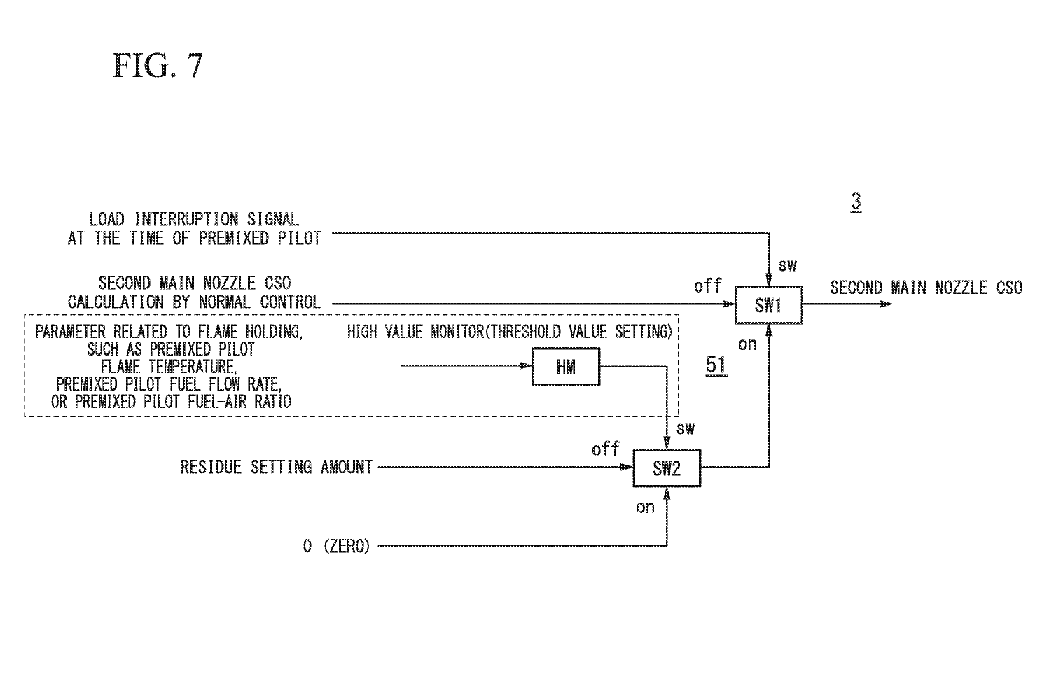

Next, a third embodiment will be described with reference to FIG. 7. However, the same sites as those in the first embodiment are denoted by the same reference numerals and description thereof is omitted, and only different points are described. FIG. 7 is a schematic circuit diagram of a gas turbine combustor control device of the third embodiment. As shown in FIG. 7, a combustor control device 51 provided in a gas turbine system 3 is provided with a high value monitor HM for setting a threshold value. The combustor control device 51 carries out automatic cut with a parameter important for flame holding, such as a premixed pilot flame temperature, a premixed pilot fuel flow rate, or a premixed pilot fuel-air ratio, as an indicator. In addition, since it is difficult to directly measure a flame temperature, an estimated value is calculated in the table from various state quantities such as a turbine casing temperature, a fuel temperature, and a fuel-air ratio.

According to the gas turbine system 3 of the third embodiment, the gas turbine system 3 can be provided with the combustor control device 51 in which it is possible to reliably prevent misfire and since it is possible to perform fuel cut at an appropriate timing, it is possible to suppress an increase in the rotating speed of the gas turbine 10.

According to the combustor control device 51 of the third embodiment, it is possible to reliably prevent misfire and since it is possible to perform fuel cut at an appropriate timing, it is possible to suppress an increase in the rotating speed of the gas turbine 10.

According to a gas turbine combustor control method of the third embodiment, it is possible to reliably prevent misfire and since it is possible to perform fuel cut at an appropriate timing, it is possible to suppress an increase in the rotating speed of the gas turbine 10.

### Fourth Embodiment

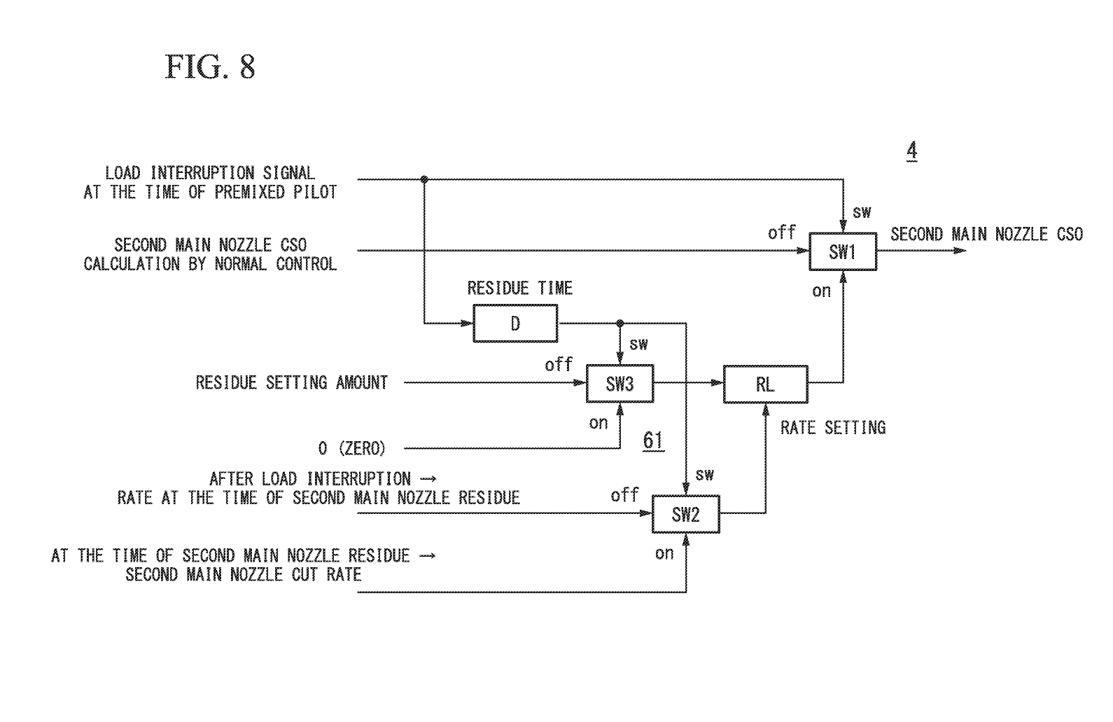

Next, a fourth embodiment will be described with reference to FIG. 8. However, the same sites as those in the first embodiment are denoted by the same reference numerals and description thereof is omitted, and only different points are described. FIG. 8 is a schematic circuit diagram of a gas turbine combustor control device of the fourth embodiment. As shown in FIG. 8, a combustor control device 61 provided in a gas turbine system 4 is provided with a rate limiter RL for setting a rate. The rate limiter RL sets the rate based on the output from a switch SW3 for setting a residue setting amount, and the output from the switch SW2.

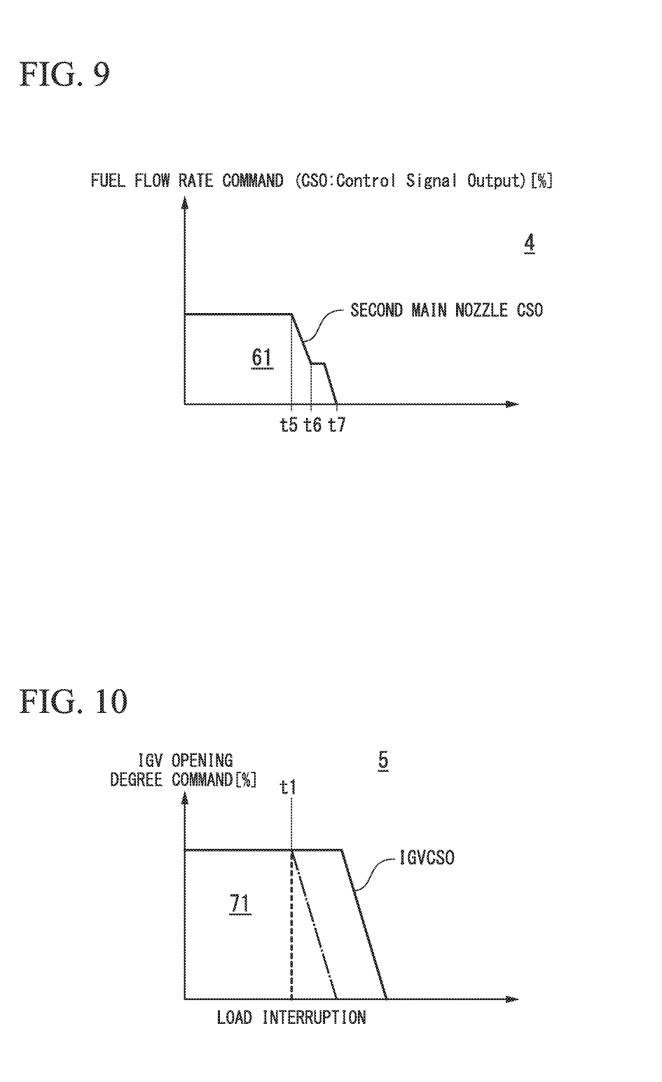

FIG. 9 is a timing chart describing a gas turbine combustor control method of the fourth embodiment. As shown in FIG. 9, in the gas turbine combustor control method, the residue setting amount is set so as to be reduced in a stepwise manner at time t6 and time t7 after time t5.

According to the gas turbine system 4 of the fourth embodiment, the gas turbine system 4 can be provided with the combustor control device 61 in which waste of fuel can be prevented by setting in detail the amount of fuel gas supplied to the second main nozzle 15.

According to the combustor control device 61 of the fourth embodiment, waste of fuel can be prevented by setting in detail the amount of fuel gas supplied to the second main nozzle 15.

According to the gas turbine combustor control method of the fourth embodiment, waste of fuel can be prevented by setting in detail the amount of fuel gas supplied to the second main nozzle 15.

### Fifth Embodiment

Next, a fifth embodiment will be described with reference to FIG. 10. However, the same sites as those in the first embodiment are denoted by the same reference numerals and description thereof is omitted, and only different points are described. FIG. 10 is a timing chart describing a gas turbine combustor control method of the fifth embodiment. As shown in FIG. 10, a gas turbine system 5 of the fifth embodiment is provided with a combustor control device 71. In the gas turbine combustor control method of this embodiment, an air flow rate is adjusted by adjusting an opening degree of the inlet guide vane 22 along with control of the combustion side. Here, in the adjustment of the opening degree of the inlet guide vane 22, dead time and a rate can be set as parameters. For example, as shown by an imaginary line in FIG. 10, an air flow rate can be increased by setting dead time or reducing a rate after there is load interruption at time t1, as compared to a case where the inlet guide vane is closed at a mechanical maximum speed.

According to the gas turbine system 5 of the fifth embodiment, the gas turbine system 5 can be provided with the combustor control device 71 in which an air flow rate is increased and thus the power of the compressor 21 can be increased, and therefore, the maximum rotating speed of the gas turbine 10 can be suppressed.

According to the combustor control device 71 of the fifth embodiment, an air flow rate is increased and thus the power of the compressor 21 can be increased, and therefore, the maximum rotating speed of the gas turbine 10 can be suppressed.

According to the gas turbine combustor control method of the fifth embodiment, the air flow rate is increased and thus the power of the compressor 21 can be increased, and therefore, the maximum rotating speed of the gas turbine 10 can be suppressed.

In addition, the gas turbine system, the gas turbine combustor control device, and the gas turbine combustor control method are not limited to the respective embodiments described above, and appropriate modifications, improvements, or the like can be made.

For example, some or all of the second embodiment, the third embodiment, the fourth embodiment, and the fifth embodiment may be combined with each other.

### INDUSTRIAL APPLICABILITY

According to the gas turbine system, the gas turbine combustor control device, and the gas turbine combustor control method described above, it is possible to reliably prevent the misfire of the combustor.

### REFERENCE SIGNS LIST

1: gas turbine system

2: gas turbine system

3: gas turbine system

4: gas turbine system

5: gas turbine system

10: gas turbine

11: combustor control device

13: pilot nozzle

14: first main nozzle

15: second main nozzle

16: load interruption detector

17: pilot nozzle flow rate control unit

18: first main nozzle flow rate control unit

19: second main nozzle flow rate control unit

41: combustor control device

51: combustor control device

61: combustor control device

71: combustor control device

1-7. (canceled)

8. A gas turbine combustor control device comprising:
a load interruption detector which detects load interruption of a gas turbine;
a pilot nozzle flow rate control unit which increases the amount of premixed fuel supplied to a pilot nozzle, based on detection of the load interruption;
a first main nozzle flow rate control unit which reduces the amount of premixed fuel supplied to a first main nozzle, based on detection of the load interruption; and
a second main nozzle flow rate control unit which reduces the amount of premixed fuel supplied to a second main nozzle to a predetermined amount, based on detection of the load interruption, and then further reduces the amount of premixed fuel supplied after the elapse of a predetermined time.

9. The gas turbine combustor control device according to claim 8, wherein the combustor control device temporarily reduces a flow rate of the first main nozzle, based on detection of the load interruption.

10. The gas turbine combustor control device according to claim 8, wherein the combustor control device reduces the amount of premixed fuel supplied to the second main nozzle with a parameter required for a flame as an indicator.

11. The gas turbine combustor control device according to claim 8, wherein the combustor control device sets delay time when reducing the amount of premixed fuel supplied to the second main nozzle to a predetermined amount, based on detection of the load interruption, and then further reducing the amount of premixed fuel supplied after the elapse of a predetermined time.

12. The gas turbine combustor control device according to claim 8, wherein the combustor control device includes adjustment of an opening degree of an inlet guide vane provided in the gas turbine.

13. A gas turbine system comprising:
a gas turbine provided with a combustor comprising
a pilot nozzle which injects premixed fuel, and
a first main nozzle and a second main nozzle which are provided around the pilot nozzle and inject premixed fuel; and
a combustor control device according to claim 8.

14. A gas turbine system comprising:
a gas turbine provided with a combustor comprising
a pilot nozzle which injects premixed fuel, and
a first main nozzle and a second main nozzle which are provided around the pilot nozzle and inject premixed fuel; and
a combustor control device according to claim 9.

15. A gas turbine system comprising:
a gas turbine provided with a combustor comprising
a pilot nozzle which injects premixed fuel, and
a first main nozzle and a second main nozzle which are provided around the pilot nozzle and inject premixed fuel; and
a combustor control device according to claim 10.

16. A gas turbine system comprising:
a gas turbine provided with a combustor comprising
a pilot nozzle which injects premixed fuel, and
a first main nozzle and a second main nozzle which are provided around the pilot nozzle and inject premixed fuel; and
a combustor control device according to claim 11.

17. A gas turbine system comprising:
a gas turbine provided with a combustor comprising
a pilot nozzle which injects premixed fuel, and
a first main nozzle and a second main nozzle which are provided around the pilot nozzle and inject premixed fuel; and
a combustor control device according to claim 12.

18. A gas turbine combustor control method comprising:
a load interruption detection step of detecting load interruption of a gas turbine;
a pilot nozzle flow rate control step of increasing the amount of premixed fuel supplied to a pilot nozzle, based on detection of the load interruption;
a first main nozzle flow rate control step of reducing the amount of premixed fuel supplied to a first main nozzle, based on detection of the load interruption; and
a second main nozzle flow rate control step of reducing the amount of premixed fuel supplied to a second main nozzle to a predetermined amount, based on detection of the load interruption, and then further reducing the amount of premixed fuel supplied after the elapse of a predetermined time.
